(19) United States
(12) Patent Application Publication
(10) Pub. No.: US 2022/0018993 A1
(43) Pub. Date: Jan. 20, 2022

(54) Reflection-Reducing Layer System and Method for Producing A Reflection-Reducing Layer System

(71) Applicant: Fraunhofer-Gesellschaft zur Foerderung der angewandten Forschung e.V., München (DE)

(72) Inventors: Ulrike Schulz, Jena (DE); Friedrich Rickelt, Jena (DE); Peter Munzert, Jena (DE); Anne Gärtner, Jena (DE); Nancy Gratzke, Jena (DE); Kevin Füchsel, Jena (DE)

(21) Appl. No.: 17/370,393

(22) Filed: Jul. 8, 2021

(30) Foreign Application Priority Data
Jul. 17, 2020 (DE) 102020118959.1

(51) Int. Cl. G02B 1/111; B05D 3/14

(52) U.S. Cl. CPC G02B 1/111; B05D 3/148

(57) ABSTRACT

In an embodiment a layer system includes an effective refractive index profile extending between a substrate-side surface and an interface with an ambient medium, wherein an effective refractive index of the layer system decreases on average from the substrate-side surface in a direction of the interface with the ambient medium, wherein the effective refractive index profile has at least two local minima, and wherein a local minimum closest to the interface with the ambient medium is spaced from the interface.

### CROSS-REFERENCE TO RELATED APPLICATIONS

This application claims priority of German Application No. 102020118959.1, filed on Jul. 17, 2020, which application is hereby incorporated herein by reference.

### TECHNICAL FIELD

The present application relates to a reflection-reducing layer system and a method for producing a reflection-reducing layer system.

### BACKGROUND

Interference layer systems, nanostructures or porous layers can be applied as antireflection coatings of surfaces.

German Patent No. DE 10 2013 106 392 B4 describes a method for producing nanostructures that can also be used to apply antireflection coatings to plastic surfaces and other organic surfaces. This makes it possible to achieve an antireflection coating in the visual spectral range for perpendicular incidence of light in which the residual reflection is about 0.5%.

However, a more spectrally broadband antireflection coating is often required, which also provides good antireflection for large angles of incidence. For large angles of incidence, complex interference coating systems can be calculated and produced using the known thin-film materials. However, the residual reflectance that can be achieved simultaneously for many angles of light incidence is severely limited. In particular, values in the range of several percent are typically achieved for the visible spectral range at angles of light incidence of 60° to the normal, if the reflection for perpendicular light incidence is to be <0.5%. Reflection at 70° is then always at values in the range of 15-20%.

In addition, the use of interference coating systems for extending the anti-reflective effect beyond the visible spectral range is theoretically limited. This is discussed in the article by A. V. Tikhonravov, et al. entitled “Estimation of the average residual reflectance of broadband antireflective coatings” in Appl. Opt. Opt. 47, C124-C130 (2008).

Furthermore, it is known that porous layers or nanostructures can be used for antireflection coatings. Particularly favorable would be a particularly thick gradient layer with gradually decreasing refractive index (J. A. Dobrowolski et al., “Toward perfect antireflection coatings. Numerical investigation,” Appl. Opt. 41, 3075-3083 (2002). However, especially for substrates to be coated or glasses with a refractive index of about 1.5, the possibilities for producing an appropriate gradient are limited.

### SUMMARY

Embodiments provide a reflection reduction for a wide spectral range and at the same time a wide range of the angle of light incidence and/or a reflection reduction with low polarization dependence. Further embodiments provide a method by which a reflection-reducing coating can be reliably produced.

A reflection-reducing layer system is disclosed which is arranged, in particular deposited, for example on a substrate. The term “substrate” generally denotes an element which is to be provided with a reflection-reducing coating. For example, the substrate is a glass substrate or a plastic substrate. For example, the substrate is an optical component or a part thereof or a preliminary stage of an optical component to be manufactured.

For example, the reflection-reducing layer system extends between a substrate-side surface and an interface with an ambient medium, for example a gas such as air.

According to at least one embodiment of the reflection-reducing layer system, the reflection-reducing layer system has an effective refractive index profile. The effective refractive index profile indicates the variation of the effective refractive index between the substrate-side surface and the interface with the ambient medium.

According to at least one embodiment of the reflection-reducing layer system, the effective refractive index of the layer system decreases on average from the substrate-side surface in the direction of the interface with the ambient medium. In particular, this means that a linear approximation to the course of the effective refractive index profile from the substrate-side surface in the direction of the interface represents a straight line with a negative slope.

According to at least one embodiment of the reflection-reducing layer system, the effective refractive index profile has at least two local minima. Thus, when seen from the local minimum, the effective refractive index increases in two mutually opposite directions. For example, the effective refractive index profile has between and including two and six local minima. A local maximum may be located between two adjacent local minima.

Thus, the effective refractive index profile does not decrease continuously over the entire thickness of the reflection-reducing layer system from the substrate-side surface to the interface with the ambient medium, but only on average.

According to at least one embodiment of the reflection-reducing layer system, a local minimum closest to the interface with the ambient medium is spaced from the interface. Thus, from this local minimum to the interface with the ambient medium, the effective refractive index increases. This closest local minimum can in particular also be the global minimum within the reflection-reducing layer system. Immediately at the interface with the ambient medium, the effective refractive index is preferably greater than in the region of the local minimum closest to the interface.

In at least one embodiment of the reflection-reducing layer system, the reflection-reducing layer system has an effective refractive index profile extending between a substrate-side surface and an interface with an ambient medium, wherein the effective refractive index of the layer system decreases on average from the substrate-side surface toward the interface with the ambient medium. The effective refractive index profile has at least two local minima, with a local minimum nearest the interface with the ambient medium spaced from the interface.

It has been found that such a reflection-reducing layer system, in which the effective refractive index decreases toward the ambient medium only on average but has several local minima in between, can be used to produce highly efficient antireflection coatings that can be characterized by a large spectral broadband and/or a large angular range of the angle of incidence of the radiation and/or a low dependence on the polarization of the radiation, in particular even at comparatively large angles of incidence, such as above 30°. In contrast to conventional layer systems, the reflectivities for perpendicularly and parallel polarized radiation components in particular can be specifically adjusted. In the following, the angle of incidence is given according to the usual convention with reference to the normal to the substrate-side surface, so that an angle of 0° corresponds to a perpendicular incidence of the radiation.

The radiation in which the reflection-reducing layer system has a reflection-reducing effect is not limited to the visible spectral range, but can also be ultraviolet radiation or infrared radiation.

According to at least one embodiment of the reflection-reducing layer system, the effective refractive index profile has at least two local maxima spaced from the substrate-side surface. One of the local maxima may be formed at the interface with the ambient medium. In the region of at least one, several or even all local maxima, the reflection-reducing layer system has, for example, an inorganic layer in each case. The inorganic layer can also be formed by two or more inorganic sublayers. This inorganic layer may be adjacent on one side or both sides to a material having a lower refractive index, such as an organic material. For example, the reflection-reducing layer system has an alternating sequence of inorganic layers and organic layers, with at least one local minimum of refractive index in an organic layer and at least one local maximum in an inorganic layer. Preferably, the organic layers are not pure organic layers, but have an inorganic-organic mixed material.

According to at least one embodiment of the reflection-reducing layer system, the effective refractive index in at least one local maximum is smaller than the refractive index of the substrate. The effective refractive index may also be smaller than the refractive index of the substrate in two or more local maxima, in particular also in all local maxima. Obtaining a refractive index profile that decreases on average towards the interface with the ambient medium is thus simplified.

According to at least one embodiment of the reflection-reducing layer system, the effective refractive index in at least one of the local maxima is smaller than in a further local maximum arranged between this local maximum and the substrate-side surface. In particular, the further the local maximum is from the substrate-side surface, the smaller the effective refractive index may be in the local maxima.

According to at least one embodiment of the reflection-reducing layer system, an effective refractive index in at least one of the local minima is between 1.05 and 1.12, inclusive, so the effective refractive index is very close to the refractive index of air.

According to at least one embodiment of the reflection-reducing layer system, an effective refractive index is between 1.14 and 1.40 inclusive from the interface with the ambient medium for at least 10 nm in the direction of the substrate. For example, the interface with the ambient medium is formed by an inorganic material. This inorganic material may form a cover layer of the reflection-reducing layer system. In particular, the effective refractive index in this region near the interface with the ambient medium is greater than in the region of the reflection-reducing layer system immediately adjacent thereto. The refractive index of the inorganic material for the cover layer per se may also be significantly greater than 1.40.

According to at least one embodiment of the reflection-reducing layer system, the effective refractive index changes continuously at least in places between a local maximum and a local minimum. Such a continuous change can be achieved, for example, by structuring a layer in the lateral direction, i.e., in a direction perpendicular to the deposition direction of the reflection-reducing layer system, before another layer is deposited, so that the effective refractive index results from an averaging of the refractive indices of the two layers in the region of the structuring. Alternatively or complementarily, such a gradient of the refractive index can be obtained by a gradient progression in at least one property of a material of one or more layers. This can be achieved, for example, of the production by a post-treatment of a layer, in particular an organic layer, and will be described in more detail below in connection with the method.

Furthermore, a method for producing a reflection-reducing layer system is disclosed. The method described is particularly suitable for the reflection-reducing layer system described above. Features cited in connection with the reflection-reducing layer system can therefore also be used for the method, and vice versa.

According to at least one embodiment of the method, the method comprises a step of providing a substrate. The substrate is, for example, a glass substrate or a plastic substrate. The substrate may be pre-treated, for example coated or textured. In particular, the substrate may also be planar or curved.

According to at least one embodiment of the method, the method comprises a step of depositing an organic layer. In particular, the organic layer is deposited on an inorganic material, for example on an inorganic layer deposited before the organic layer. For example, the organic layer is deposited directly subsequent to the inorganic layer. The inorganic layer and/or the organic layer may have one or more sublayers. For example, a thickness of the inorganic layer is between 5 nm and 50 nm, inclusive. A material of the inorganic layer has, for example, a refractive index between 1.35 and 2.4 inclusive, in particular between 1.35 and 1.8 inclusive.

The thickness of the organic layer is preferably greater than the thickness of the inorganic layer. For example, the thickness of the organic layer is between 80 nm and 1000 nm, inclusive.

In particular, the inorganic layer and the organic layer can be evaporated under vacuum, for example by a plasma process, in particular in the same apparatus.

According to at least one embodiment of the method, the method comprises a step in which the organic layer is patterned by a plasma etching process. At this stage, the organic layer is preferably the uppermost, i.e. the most recently applied, layer on the substrate. As a result of the structuring, elevations are formed in the organic layer as seen from the substrate, and depressions are formed between the elevations. For example, a single structure of the structuring, such as an elevation, has a height-to-width ratio (also aspect ratio) of at least 1.0. For example, the height-to-width ratio is greater than 1.5 or greater than 2. The depressions may extend completely or only partially through the organic layer. The plasma etching process may further change the chemical composition of the organic layer. A change in chemical composition can be detected, for example, via a change in the associated FTIR (Fourier Transform Infrared Spectroscopy) spectra. In particular, this may cause the effective refractive index of the organic layer to change, in particular to decrease with increasing distance from the substrate.

According to at least one embodiment of the method, the method comprises a step of depositing at least one further inorganic layer. A refractive index of the material of the further inorganic layer is, for example, between 1.35 and 2.4 inclusive, in particular between 1.35 and 1.8 inclusive. A thickness of the further inorganic layer is, for example, between 5 nm and 60 nm inclusive. The deposition of the further inorganic layer is carried out in particular in such a way that the inorganic layer replicates the structuring of the underlying organic layer without completely leveling the structuring. In particular, the inorganic layer also covers the side surfaces of the elevations, for example completely.

According to at least one embodiment of the method, the further inorganic layer grows together on the side facing away from the substrate, at least between some adjacent elevations. In this process, cavities can form in the layer system. As a result of these cavities, the effective refractive index is advantageously lowered further in comparison with a complete filling of the depressions of the structuring. The formation of such cavities can be promoted in particular by a comparatively large height-to-width ratio of the individual structures of the structuring.

According to at least one embodiment of the method, the method comprises the step of a post-treatment in which the chemical composition of the organic material of the organic layer is changed and the refractive index is reduced. In particular, the post-treatment step at least partially removes, decomposes, or chemically transforms the material of the organic layer. For example, the post-treatment may cause material of the organic layer to be partially converted to NH3 or other gaseous components that can escape from the organic layer, and/or cause the organic layer to become porous. This reduces the effective refractive index of the organic layer. At the time of post-treatment, the inorganic layer deposited thereafter is already present on the uppermost organic layer. In particular, the post-treatment can be carried out in such a way that the inorganic layer already disposed on the organic layer is not, or at least not significantly, affected by the post-treatment. Furthermore, the post-treatment preferably does not change, or at least does not significantly change, the basic shape of the structuring.

The effect of the change in the organic material, such as the decomposition of the organic material, may increase with increasing distance from the substrate, so that a refractive index gradient may be formed or enhanced by the post-treatment. Thus, in this region of the reflection-reducing layer system to be fabricated, the refractive index may continuously decrease with increasing distance from the substrate. Furthermore, the change in effective refractive index due to post-treatment is adjustable over the duration of the post-treatment. For example, the lateral extent of the protrusions may decrease as the etching time increases, so that the proportion of the effective refractive index accounted for by the material between the protrusions, such as the inorganic material and/or the gas in the voids, increases. In particular, the post-treatment can also be carried out in such a way that the organic material is almost completely removed in its originally deposited form.

The reduced amount of the original organic material can further reduce the radiation transmission of the entire layer system. In particular, it has been found that the radiation transmission of the organic material for radiation in the ultraviolet spectral range can be increased by the post-treatment. As a result, absorption losses can be advantageously reduced.

According to at least one embodiment of the method, deposition of an inorganic cover layer takes place. In particular, the inorganic cover layer forms the last layer of the reflection-reducing layer system and thus the interface with an ambient medium for the finished reflection-reducing coating.

In at least one embodiment of the method, the method comprises the steps, in particular in the order indicated:

a) providing a substrate;

b) depositing an organic layer on an inorganic layer;

c) forming a structuring of the organic layer by a plasma etching process, wherein a single structure of the structuring in particular has a height-to-width ratio of at least 1.0 and the chemical composition of the organic layer changes;

d) depositing at least one further inorganic layer;

e) performing a post-treatment in which the chemical composition of the organic material of the organic layer changes and the refractive index decreases; and

f) depositing an inorganic cover layer.

A thickness of the inorganic layer and/or the further inorganic layer and/or the cover layer is, for example, between 5 nm and 60 nm inclusive, in particular between 5 nm and 30 nm inclusive. A material of the inorganic layer and/or the further inorganic layer and/or the cover layer has, for example, a refractive index between 1.35 and 2.4 inclusive, in particular between 1.35 and 1.8 inclusive.

By means of the deposition of the inorganic layers, local maxima of the resulting refractive index profile can be achieved within the reflection-reducing layer system. In the organic layers arranged in between, a refractive index gradient can be achieved, in particular by means of the structuring and/or the post-treatment, so that the refractive index in the organic layers decreases at least in places with increasing distance from the substrate. Overall, for example, a refractive index profile can be achieved that decreases on average from the substrate and has at least two local minima.

According to at least one embodiment of the method, the organic layer in step b) comprises at least one annularly arranged grouping with conjugated nitrogen and carbon atoms. In particular, the organic layer is vacuum-deposited and has, for example, a thickness between 80 nm and 1000 nm, inclusive. Preferably, the organic material for the organic layer has a molecular structure derivable from purine, pyrimidine or triazine.

According to at least one embodiment of the method, the structuring of the organic layer forms depressions extending between 10 nm and 300 nm, inclusive, into the organic layer. By a structuring with depressions in this range, gradual changes in the refractive index profile can be reliably achieved.

The depressions can also extend completely through the organic layer in the vertical direction. In this case, the underlying inorganic layer may be exposed in the region of the depressions. Two inorganic layers, between which the organic layer with the structuring is located, can be directly adjacent to each other in the region of the depressions. This can improve the adhesion of the layers to one another.

According to at least one embodiment of the method, a plasma etching process is carried out during the post-treatment, in which a basic shape of the structuring formed in the previously formed structuring is retained. Thus, the geometry and/or the height-to-width ratio of the individual structures of the structuring do not change, or at least do not change significantly, as a result of the post-treatment.

According to at least one embodiment of the method, the post-treatment includes a thermal treatment, for example at a temperature above 70° C. Such post-treatment may be performed alternatively or in addition to a plasma etching process.

According to at least one embodiment of the method, steps b) to d) are performed repeatedly, for example at least twice, at least three times, at least four times or more. The more often these steps are performed, the more local maxima are formed, each of which may be formed by an inorganic layer.

According to at least one embodiment of the method, at least steps b) to d) are carried out in an apparatus in a closed vacuum process. The production of the reflection-reducing layer system can thus be carried out particularly efficiently. In particular, all steps in which deposition, structuring or post-treatment is carried out can also be carried out in one apparatus.

According to at least one embodiment of the method, a pretreatment of the substrate is carried out before step b), in which a structuring is formed that extends into the substrate. Such a pretreatment is particularly suitable for plastic substrates. During the pretreatment, a plasma process can alternatively or supplementarily be carried out, with which an activation with a lowering of the contact angle takes place. Furthermore, alternatively or supplementarily, an inorganic material can be deposited on the substrate. In particular, the inorganic material may be deposited before the structuring is formed. For example, the structuring extends between 10 and 200 nm inclusive into the substrate.

The reflection-reducing layer system and the manufacturing method are generally suitable for optical components, such as those made of glass or plastic, in particular for lenses, lens arrays, optical windows, miniaturized plastic lenses or micro-optical components or parts thereof. For example, the optical components may be for lenses, cameras, for lighting, for displays, for virtual reality, or for augmented reality.

In particular, the following effects can be achieved with the reflection-reducing layer system and the method, respectively.

The reflection-reducing layer system is also suitable for, in particular, transparent substrates with a comparatively low refractive index, for example with a refractive index between 1.35 and 1.7.

In the visible spectral range, i.e. in the wavelength range between 400 and 700 nm, a particularly low residual reflection can be achieved, for example of less than 0.3% on average for the entire angular range of the angle of incidence from 0° to 60°.

Low residual reflection in the visible spectral range can also be achieved for even larger angular ranges, for example no more than 1% on average for all angles of incidence from 0° to 70°.

Polarization effects can be avoided because the layer structure of the reflection-reducing layer system can be designed in such a way that the reflectivity for perpendicularly and parallel polarized radiation components are comparatively close to each other even for comparatively large angles of light incidence. For example, the reflection-reducing layer system can be configured such that the reflectivities for perpendicularly and parallel polarized radiation components differ from one another by at most 10 percentage points or by at most 5 percentage points over an entire spectral range of at least 100 nm and/or at angles of more than 300 over an entire angular range of the angle of incidence of at least 20°, for example from 40° to 60° to the normal. The curves of the reflectivities as a function of the wavelength and/or the angle of incidence can also cross, so that the reflectivities for perpendicularly and parallel polarized radiation components are the same for a wavelength or for an angle of incidence, respectively. In particular, the reflectivity for perpendicularly polarized radiation components can also be smaller than for parallel polarized radiation components in at least one wavelength range or in at least one angular range of the angle of incidence.

The scattering losses that occur can be very low compared to conventional coatings, which means that a very high transmission through the layer stack can be achieved.

Efficient antireflection coating can be achieved over an extremely broad spectral range, for example over the entire spectral range from 300 nm to 2000 nm.

Alternatively or additionally, the antireflection coating system can be designed for a particularly wide range of angles of incidence, for example over the entire angular range from perpendicular incidence (i.e., 0°) to grazing incidence of, for example, 80°.

Furthermore, the reflection-reducing layer system can be implemented in a technically reliable manner using conventional vacuum technology. This also makes the method particularly suitable for mass production.

### BRIEF DESCRIPTION OF THE DRAWINGS

Further embodiments and expediencies result from the following description of the exemplary embodiments in connection with the figures.

FIGS. 1A and 1B each show a schematic refractive index curve for an exemplary embodiment of a reflection-reducing layer system;

FIG. 2 shows a schematic representation of an exemplary embodiment for a reflection-reducing layer system in sectional view;

FIG. 3A shows a schematic representation of a refractive index curve of an exemplary embodiment for a reflection-reducing layer system;

FIG. 3B shows the corresponding resulting percentage residual reflection as a function of the wavelength of the incident radiation for different angles of incidence;

FIG. 3C shows a plot of the refractive index profile for a reference structure;

FIG. 3D shows a plot of the corresponding resulting residual reflectance as a function of wavelength for different angles of incidence of the incident radiation;

FIGS. 4A and 4B show a refractive index profile and a resulting residual reflectance, respectively, for different angles of incidence as a function of the wavelength of the incident radiation for an embodiment of a reflection-reducing layer system;

FIGS. 5A and 5B show a refractive index profile and a resulting residual reflectance, respectively, for different angles of incidence as a function of the wavelength of the incident radiation for an exemplary embodiment of a reflection-reducing layer system;

FIG. 5C shows the reflectivity for radiation components with parallel and perpendicular polarization for different angles of incidence as a function of the wavelength of the incident radiation;

FIG. 5D shows the reflectivity for incident radiation with an angle of incidence of 80° for the radiation, for the s-polarized radiation component and the p-polarized radiation component compared to the reflectivity for an uncoated substrate;

FIG. 5E shows the reflectivity at perpendicular incidence as a function of wavelength;

FIGS. 6A and 6B show a refractive index curve and a resulting residual reflectance for perpendicularly incident radiation as a function of wavelength, respectively, for an exemplary embodiment of a reflection-reducing coating system;

FIGS. 7A and 7B show a refractive index profile and a resulting residual reflection for vertically incident radiation as a function of the wavelength thereof, respectively, for an exemplary embodiment of a reflection-reducing layer system;

FIGS. 8A and 8B show a refractive index profile and resulting reflectivities, respectively, for different incident angles and s- and p-polarized radiation components as a function of the wavelength of the incident radiation for an exemplary embodiment of a reflection-reducing layer system; and

FIGS. 9A to 9H show an example of a method for producing a reflection-reducing layer structure by means of intermediate steps shown schematically in sectional view in each case.

The figures are each schematic representations and therefore not necessarily to scale. Rather, various elements, in particular layer thicknesses, may be shown exaggeratedly large for improved representability and/or better understanding. Elements that are the same, similar or have the same effect are given the same reference signs in the Figures.

### DETAILED DESCRIPTION OF ILLUSTRATIVE EMBODIMENTS

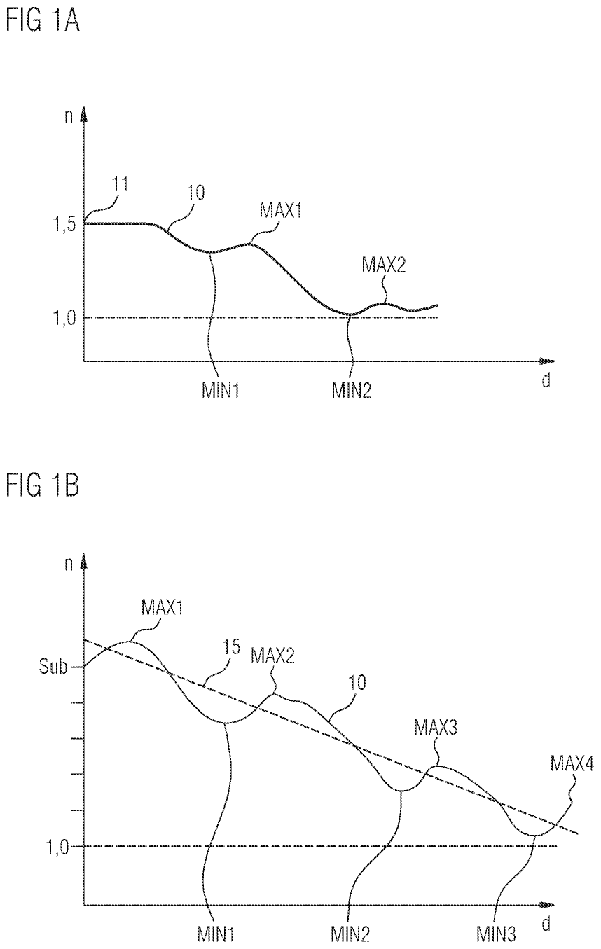

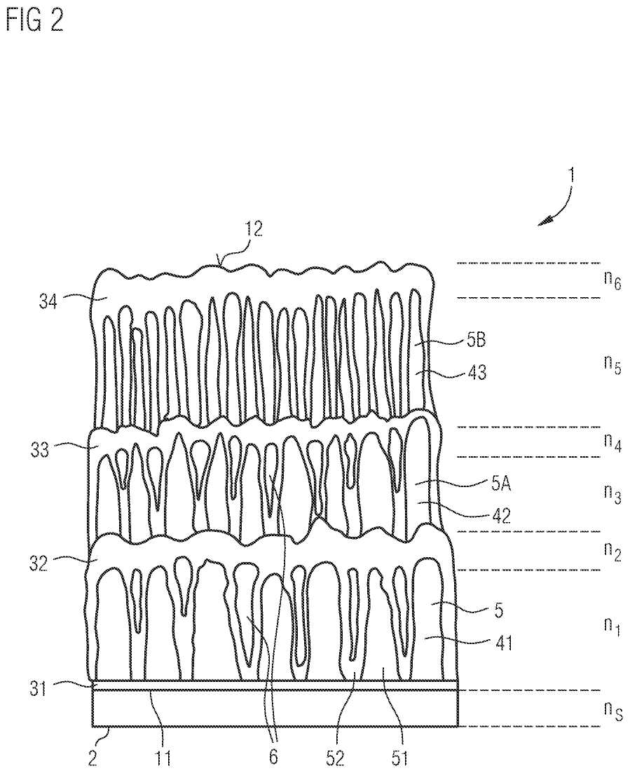

A refractive index profile for a reflection-reducing layer system according to an exemplary embodiment is shown schematically in FIG. 1A as a function of the distance 9 from a substrate. Starting from a substrate-side surface 11 at d=0, the effective refractive index 10 decreases on average in the direction toward an interface with an ambient medium 12. Here, the refractive index profile passes through a first local minimum MIN1 and a second local minimum MIN2, these local minima being spaced from both the substrate-side surface 11 and the interface with the ambient medium 12.

A local maximum MAX1 is formed between the first local minimum MIN1 and the second local minimum MIN2. The second local maximum MAX2 is located between the minimum MIN2 closest to the interface with the ambient medium and the interface with the ambient medium 11.

In the local maxima MAX1 and MAX2, the effective refractive index of the reflection-reducing layer system is in each case smaller than the refractive index of the substrate. In the exemplary embodiment shown, the substrate has a refractive index of 1.5, but the substrate may have a refractive index different from this, smaller or larger.

The refractive index in the local minima MIN1, MIN2 decreases with increasing distance from the substrate-side surface 11. Furthermore, the value of the refractive index in the maxima MAX1, MAX2 also decreases with increasing distance from the substrate. However, this is not mandatory for all local maxima MAX1, MAX2 and/or all local minima MIN1, MIN2.

Another exemplary embodiment of a refractive index profile 10 is shown in FIG. 1B. In this exemplary embodiment, the refractive index profile of the reflection-reducing layer system has four maxima MAX1, MAX2, MAX3 and MAX4. The refractive index in the maximum MAX1 closest to the substrate is greater than the refractive index of substrate 2. FIG. 1B further shows the linearly approximated course of the refractive index in the form of a straight line with negative slope 15.

The exact number of maxima and minima, respectively, the thicknesses of the layers used for the reflection-reducing layer system and the materials used for it can be set depending on the desired requirements of the reflection-reducing layer system with regard to reflectivity as a function of the wavelength and/or the angle of incidence of the incident radiation.

A schematic sectional view of an embodiment of a reflection-reducing layer system is shown in FIG. 2. The reflection-reducing layer system 1 is arranged on a substrate 2 with a refractive index nₛ. A sequence of inorganic layers 31, 32, 33, 34 is arranged on the substrate, with layers 41, 42, 43 containing organic material being arranged between each of the inorganic layers. For example, these layers have an inorganic-organic mixed material. The layers containing organic material each have a structuring 5, 5A and 5B, respectively, in the form of a nanostructuring with elevations 51 and depressions 52. The layers containing organic material are each thicker than the inorganic layers. The layer sequence results in an effective refractive index profile with schematically depicted areas n₁, n₂, n₃, n₄, n₅ and n₆, where the areas n₂, n₄ and n₆ are essentially formed by the inorganic layers. The effective refractive indices in each of these regions are greater than in the layer containing organic material immediately below. Thus, n₆>n₅, n₄>n₃, n₂>n₁ hold true. Furthermore, the average refractive index in the organic layers preferably decreases with increasing distance from the substrate 2, so that n₁>n₃>n₅ applies.

The individual structures of the structuring 5, 5A, 5B preferably each have a height-to-width ratio of at least 1.0, preferably at least 1.5 or at least 2.0. Cavities 6 are formed in places in the region of the depressions 52. These cavities 6 reduce the effective refractive index in the region of the layers 41, 42, 43 containing organic material. In the exemplary embodiment described, the reflection-reducing layer structure 1 has a refractive index profile with three local maxima, each formed by the inorganic layers. However, the number of local maxima and correspondingly the local minima can also be smaller or larger.

Suitable organic materials are, in particular, those with conjugated C═N groups and derivatives thereof. For example, a suitable material is one from the class of triazines, for example TIC (1,3,5-triallyl-1,3,5-triazine-2,4,6(1H,3H,5H)-triones), acetoguanamine (6-methyl-1,3,5-triazine-2,4-diamine), melamine (2,4,6-triamino-1,3,5-triazine), cyanuric acid (3,5-triazine-2,4,6-triol,2,4,6-trihydroxy-1,3,5-triazines), of purines, such as xanthine (2,6-dihydroxypurine), adenine (7H-purine-6-amine), guanine (2-amino-3,7-dihydropurine-6-one), the pyrimidines, for example uracil (1H-pyrimidine-2,4-dione) or UEE (uracil-5-carboxylic acid ethyl ester), the imidazoles, for example creatinine (2-amino-1-methyl-2-imidazolin-4-one) or phenylamines, for example NPB (N,N′-di(naphth-1-yl)-N,N′-diphenylbenzidine), TPB (N,N,N′,N′-tetraphenylbenzidine) or TCTA (tris(4-carbazoyl-9-ylphenyl)amine).

Suitable inorganic layers include oxides such as titanium dioxide, silicon dioxide or magnesium fluoride or nitrides.

The thicknesses of the inorganic layers 31, 32, 33, 34 are preferably each between 5 nm and 50 nm inclusive.

The thicknesses of the organic layers 41, 42, 43 are preferably between 80 nm and 1000 nm, inclusive.

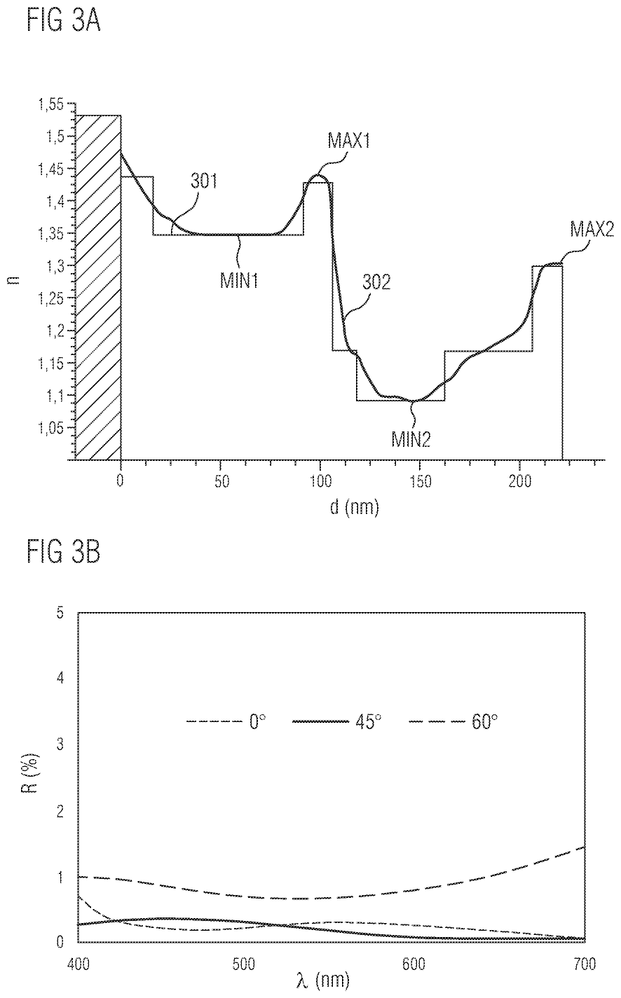

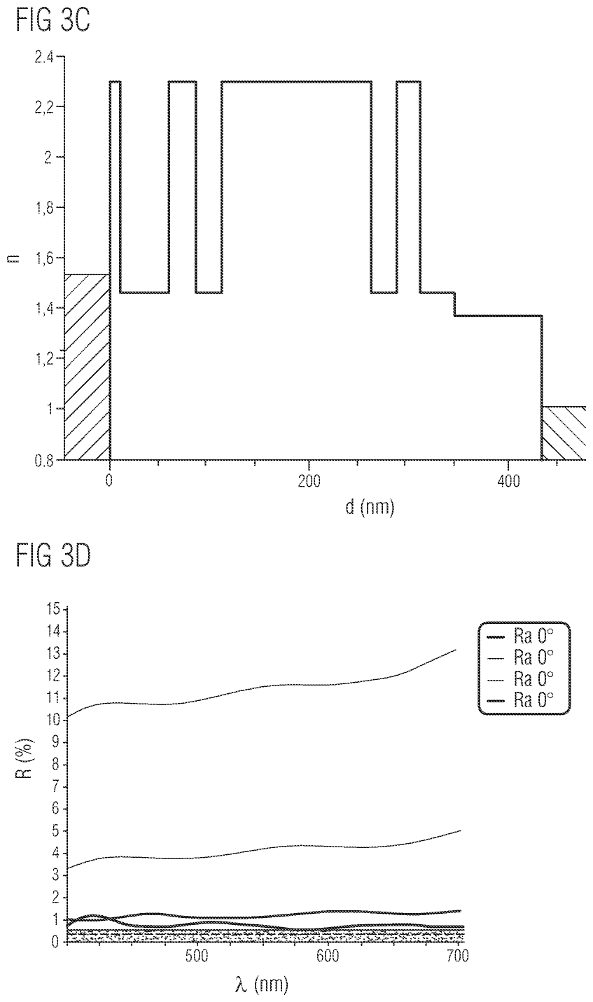

FIGS. 3A and 3B show the variation of the refractive index and the resulting reflectivities for an exemplary embodiment in which the reflectivity is optimized for a wavelength range from 400 nm to 700 nm and a range of the angle of incidence from 0° to 60°. The substrate in question is a plastic substrate sold under the trade name Zeonex E48R and has a refractive index of 1.53.

In FIG. 3A, a curve 301 shows the nominal variation of the refractive index of the material used for the respective layer as a function of the physical layer thickness d. Curve 302 shows the effective refractive index resulting from the manufacturing method described below, in which a continuous transition of the effective refractive index occurs at the nominal interfaces of individual layers in each case. The example shown in FIG. 3A can be produced by a layer sequence of patterned organic layers and vapor-deposited inorganic materials, for which, for example, four times a plasma etching process and four times a vapor deposition process can be carried out. The spectral curve of the residual reflectivity is shown in FIG. 3B. With a total layer thickness of 220 nm, the average residual reflectivity over the spectral range from 400 nm to 700 nm is 0.2% for perpendicular incidence. Averaged over the angular range from 0 to 70°, the reflectivity is 0.6%. For an angle of incidence of 60°, the reflectivity for the p-polarized radiation component is 0.4% and for the s-polarized radiation component 1.4%. For angles of incidence of 70°, the reflectivity is 3.1% for p-polarized radiation and 5.6% for s-polarized radiation.

For comparison, FIGS. 3C and 3D show an associated refractive index profile and resulting reflectivities for a conventional interference coating system of high- and low-refractive-index oxides, such as those containing titanium dioxide and silicon dioxide, optimized for an angle of incidence range of 0° to 60°.

With a total layer thickness of 440 nm, the average residual reflection at perpendicular incidence over the spectral range from 400 nm to 700 nm is 0.6%. Averaged over the angular range from 0 to 70°, the average reflectivity is 1.9%. For an angle of incidence of 60°, the reflectivity for the p-polarized radiation component is 1.6% and for the s-polarized radiation component 6.3%. For angles of incidence of 70°, the reflectivity is 7.4% for p-polarized radiation and 15.3% for s-polarized radiation.

Thus, with the described reflection-reducing layer system, significantly lower values for the reflectivities can be achieved compared to a conventional coating. Moreover, this is achievable with a lower overall layer thickness.

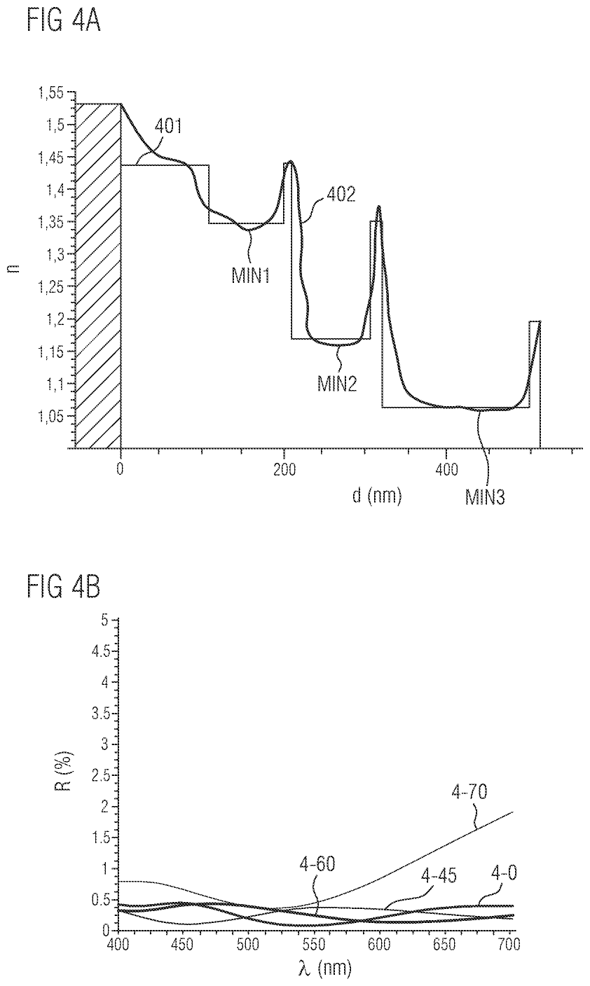

Another exemplary embodiment for a refractive index profile and resulting reflectivities is shown in FIGS. 4A and 4B. In FIG. 4A, a curve 401 shows the nominal variation of the refractive index of the material used for the respective layer as a function of the physical layer thickness d. Curve 402 shows the resulting effective refractive index. In this exemplary embodiment, the reflectivity is also optimized for the spectral range from 400 nm to 700 nm, but for an angular range of the angle of incidence from 0° to 70°. The refractive index profile here has three local maxima MAX1, MAX2, MAX3 and three local minima MIN1, MIN2, MIN3. The layer structure can be produced by plasma etching five times and vapor deposition five times and has a total thickness of 510 nm.

With a total layer thickness of 510 nm, the average residual reflection at perpendicular incidence over the spectral range from 400 nm to 700 nm is 0.2%. Averaged over the angular range from 0 to 70°, the average reflectivity is 0.3%. For an angle of incidence of 60°, the reflectivity for the p-polarized radiation component is 0.1% and for the s-polarized radiation component 0.4%. For angles of incidence of 70°, the reflectivity is 0.7% for p-polarized radiation and 0.9% for s-polarized radiation.

Compared to the previous exemplary embodiment, the reflectivities for an angle of incidence of 70° can thus be significantly reduced and even be below 1 percent.

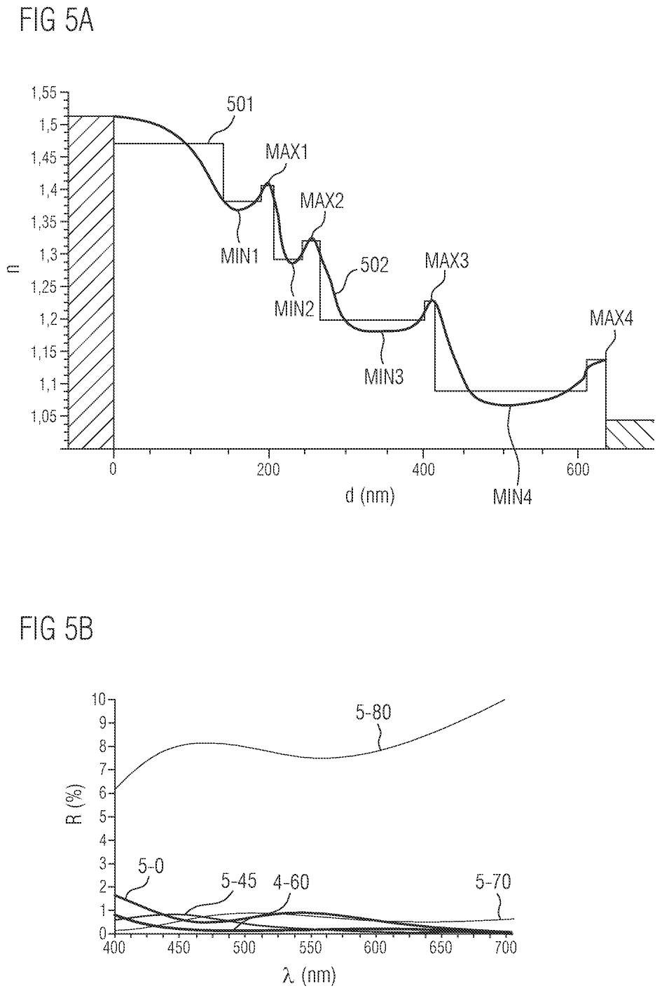

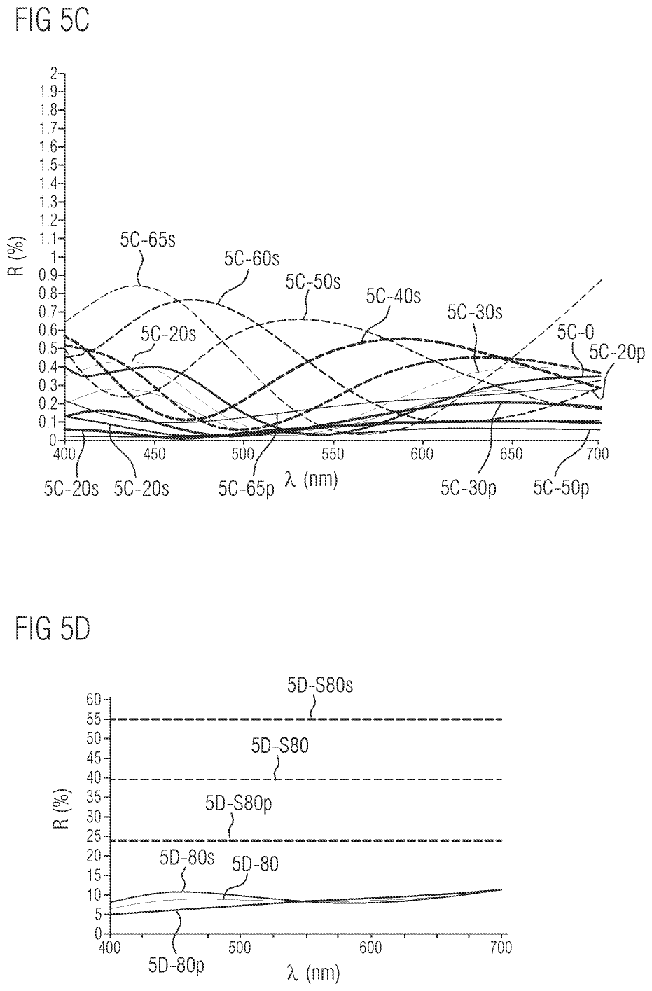

By a suitable choice of the parameters, the reflection-reducing layer system can be optimized for even larger ranges of the angle of incidence. This is illustrated by the exemplary embodiment shown in FIGS. 5A to 5E, in which the reflection-reducing layer system is optimized for the wavelength range from 400 nm to 700 nm and for an angular range of the angle of incidence from 0° to 80°. Here, the refractive index profile has four local maxima and four local minima. This layer sequence can be produced by plasma etching six times and vapor deposition six times.

In FIG. 5A, a curve 501 illustrates the nominal variation of the refractive index of the material used for the respective layer as a function of the physical layer thickness d. The curve 502 illustrates the resulting refractive index profile. Curve 502 illustrates the resulting effective refractive index.

FIG. 5B illustrates the wavelength-dependent reflectivities for angles of incidence of 0° (curve 5-0), 450 (curve 5-45), 60° (curve 5-60), 700 (curve 5-70), and 80° (curve 5-80). Up to an angle of incidence of 65°, all reflectivities are below 1%.

FIG. 5C shows the reflectivity at perpendicular incidence (curve 5C-0) and for angles of incidence of 20°, 30°, 40°, 50°, 60° and 65°, respectively for s-polarized radiation components (curves 5C-20s, 5C-30s, 5C-40s, 5C-60s and 5C-65s) and for p-polarized radiation components (curves 5C-20p, 5C-30p, 5C-40p, 5C-60p and 5C-65p).

FIG. 5D illustrates the wavelength-dependent profile of the reflectivity at an angle of incidence of 80° for the incident radiation (curve 5D-80), the s-polarized radiation component (curve 5D-80s) and p-polarized radiation component (curve 5D-80p) in comparison with the corresponding reflectivities of an uncoated substrate (curves 5D-S80, 5D-S80s, 5D-S80p). Averaged over the polarization components of the radiation, the reflectivity is below 10% over the entire wavelength range from 400 to 700 nm, while the corresponding reflectivity of an uncoated substrate would be about 40%. In addition, curves 5D-80s and 5D80-p show that the residual reflectivity depends only very weakly on the polarization of the incident radiation.

FIG. 5E illustrates the reflectivity for an angle of incidence of 0° over an extremely wide spectral range, namely from 400 nm to 2000 nm. On average, the residual reflectance in this spectral range is 0.2%.

With a total film thickness of 635 nm, the average residual reflection at perpendicular incidence over the spectral range from 400 nm to 700 nm is 0.2%. Averaged over the angular range from 0 to 70°, the average reflectivity is 0.4%. For an angle of incidence of 60°, the reflectivity for the p-polarized radiation component is 0.1% and for the s-polarized radiation component 0.4%. For angles of incidence of 70°, the reflectivity is 0.4% for p-polarized radiation and 0.8% for s-polarized radiation.

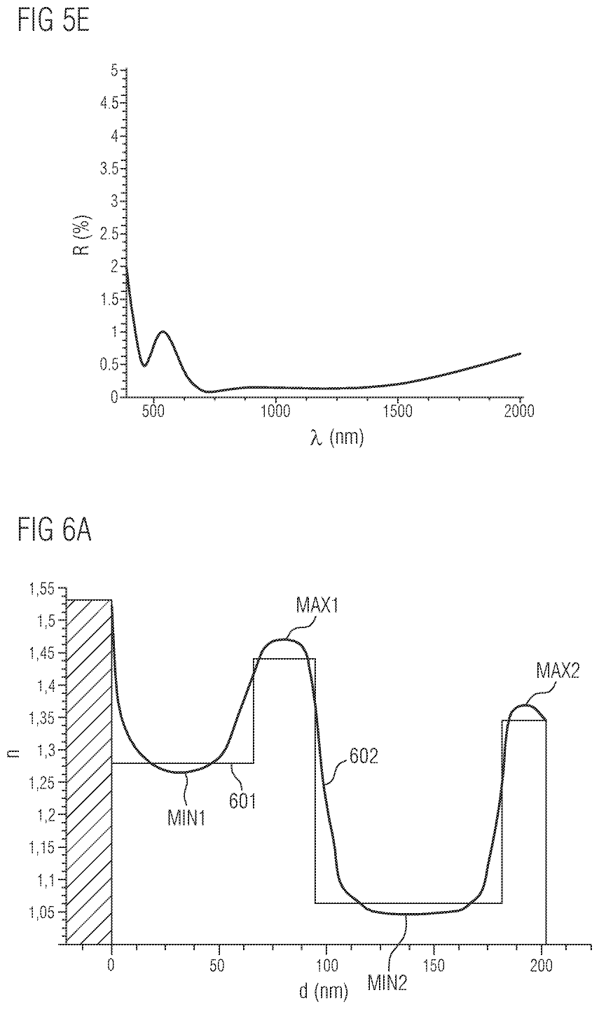

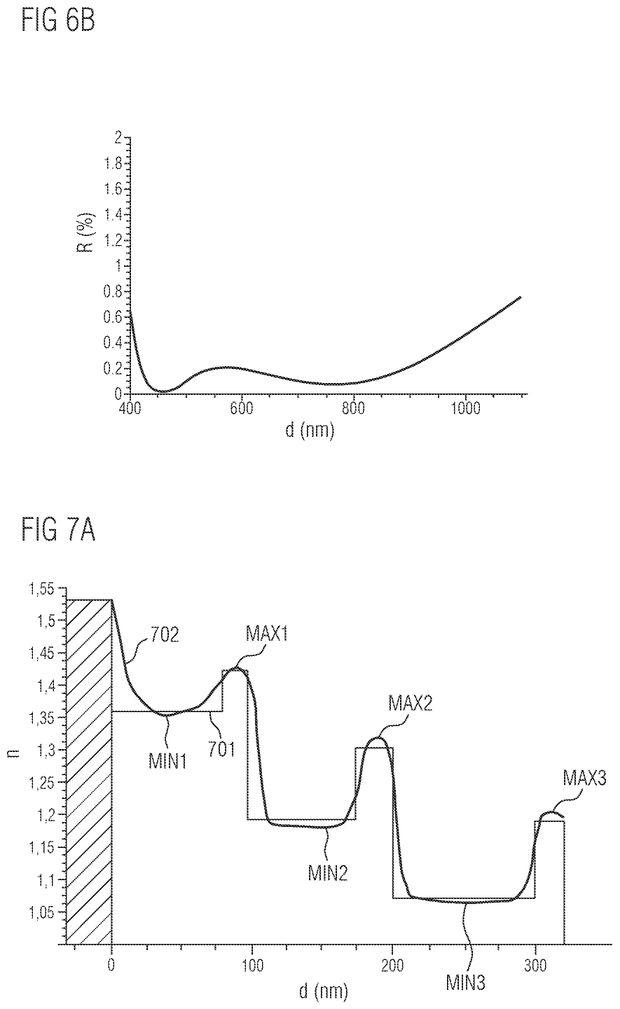

FIG. 6A illustrates an exemplary embodiment of a refractive index profile in which the reflection-reducing layer system is optimized for a wavelength range of 400 to 1000 nm and an angle of incidence of 0°. In FIG. 6A, a curve 601 illustrates the nominal variation of the refractive index of the material used for the respective layer as a function of the physical layer thickness d. Curve 602 illustrates the resulting effective refractive index. With a total layer thickness of about 200 nm, a residual reflection of <0.2% in the spectral range from 400 to 1000 nm can be achieved on average. Such a layer structure with two local minima MIN1, MIN2 can be fabricated by plasma etching three times and vapor deposition three times.

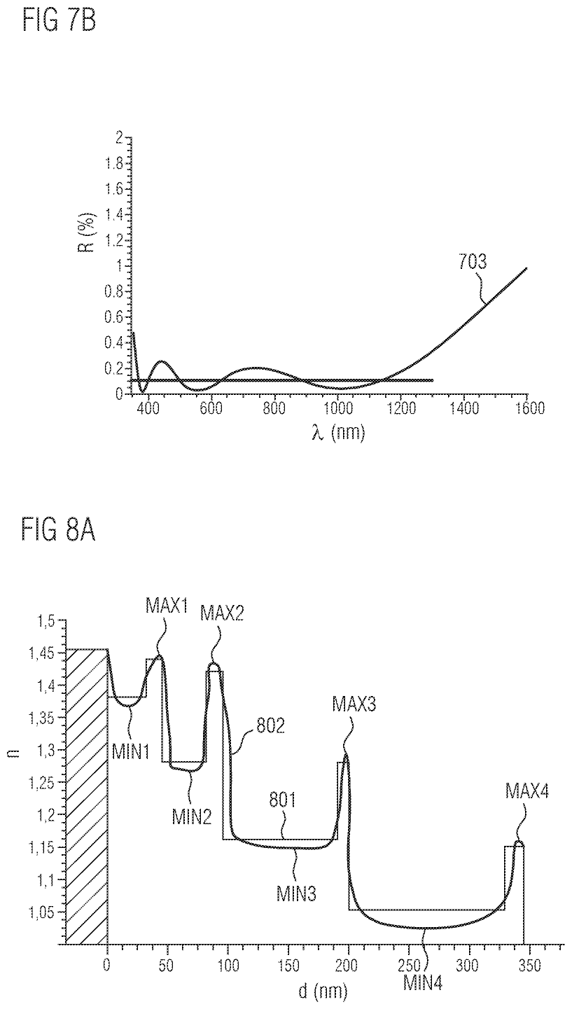

FIGS. 7A and 7B illustrate an exemplary embodiment for a reflection-reducing layer system optimized for a wavelength range from 350 nm to 1400 nm and an angle of incidence range from 0° to 60°. As shown in FIG. 7A, the reflection-reducing layer system has a refractive index profile with three local maxima MAX1, MAX2, MAX3 and three local minima MIN1, MIN2, MIN3. Over the spectral range from 350 nm to 1400 nm, a residual reflection of <0.15% on average can be achieved. This layer structure can be realized by plasma etching four times and vapor deposition four times.

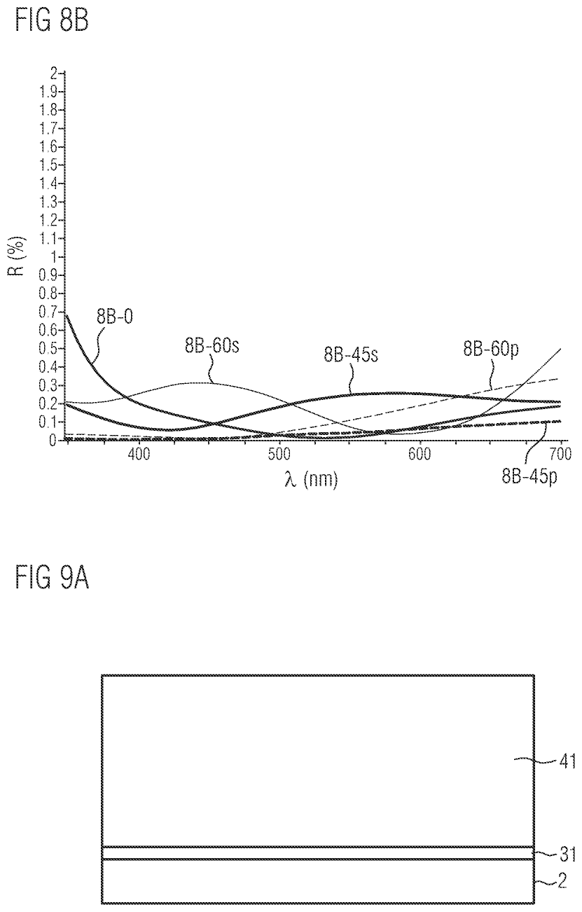

FIGS. 8A and 8B illustrate a refractive index profile and associated reflectivities for an embodiment optimized for a wavelength range from 350 nm to 700 nm and an angle of incidence range from 0° to 65°, where the reflection-reducing layer system is intended to be largely polarization neutral. For this purpose, two inorganic layers (for example MgF2 and SiO2) are first deposited. Then a first organic layer is deposited. This is followed by four etching processes and four vapor deposition processes in alternation. The resulting total layer thickness is less than 250 nm. FIG. 8B illustrates the reflectivity at an angle of incidence of 0° (curve 8B-0) and the reflectivity at 450 and 60°, respectively for s-polarized radiation components (curves 8B-45s and 8B-60s) and p-polarized radiation components (curves 8B-45p and 8B-60p). All reflectance spectra range from 400 to 700 nm for both polarization directions and are below 0.5% for angles of incidence from 0° to 65°. The average transmission for angles of incidence from 0 to 60° is more than 99.8%.

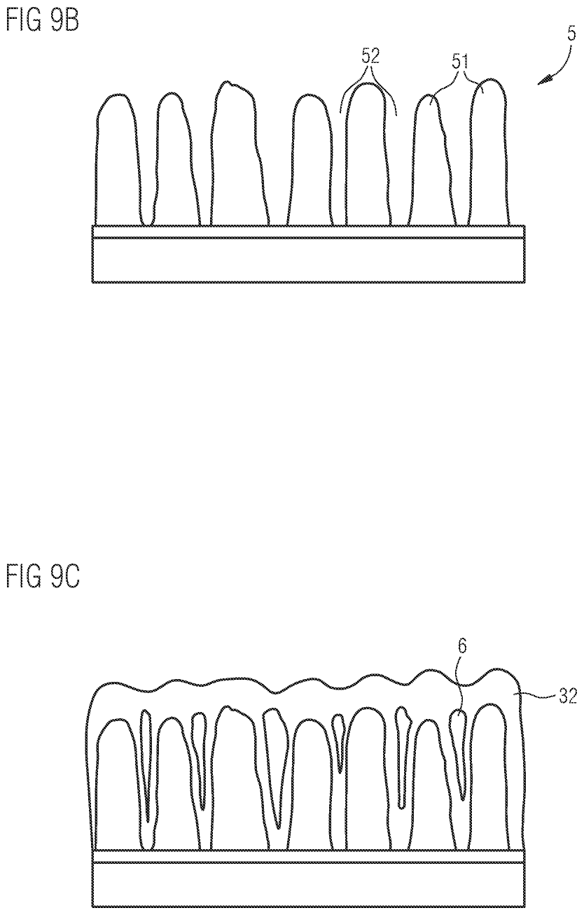

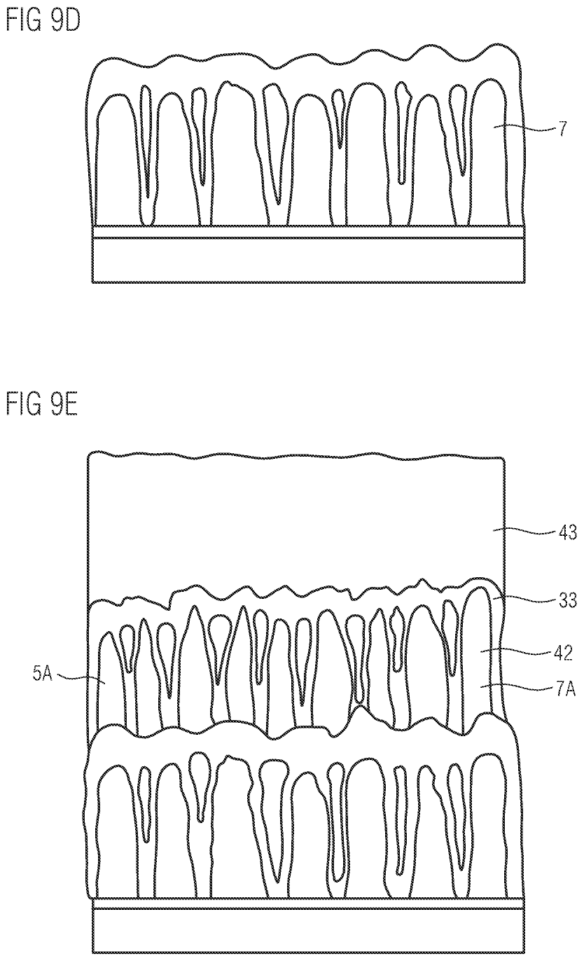

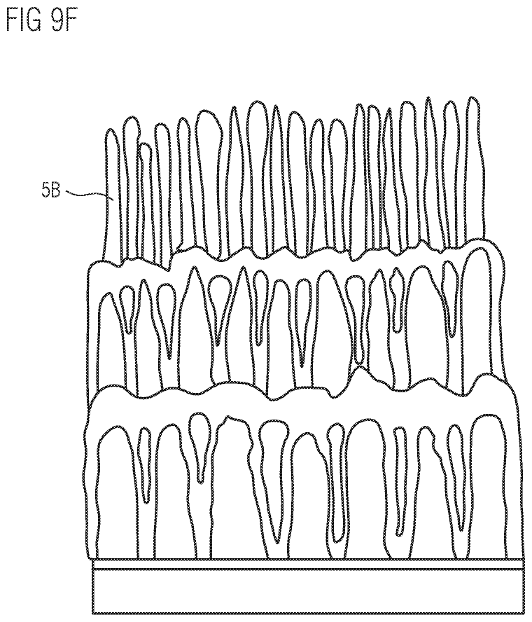

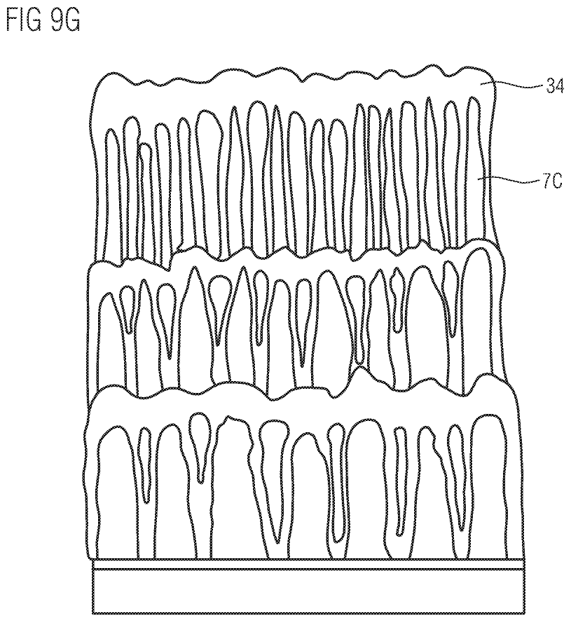

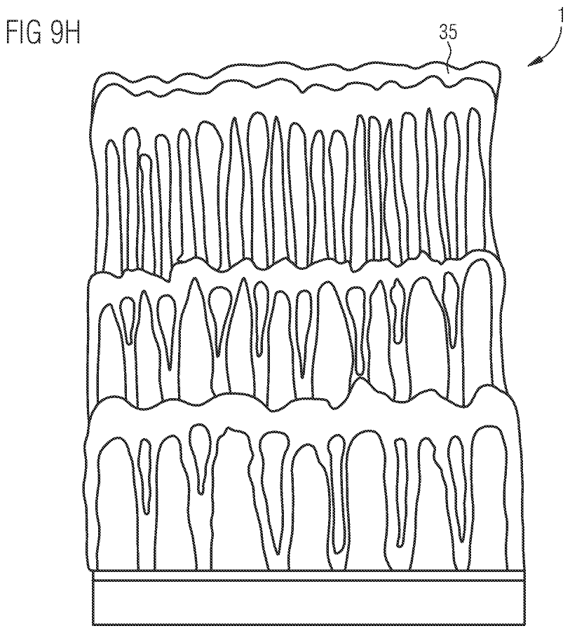

FIGS. 9A to 9H schematically illustrate an exemplary embodiment of a method for producing a reflection-reducing layer system. A substrate 2 is provided, which may be, for example, a plastic substrate or a glass substrate. For example, the refractive index of the substrate is between and including 1.35 and 1.7. Suitable plastics include polycarbonates, Zeonex, cycloolefin copolymers, polyurethanes, acrylates, epoxies or polyesters.

Instead of plastic substrates, the substrate 2 can also be, for example, a quartz substrate, an optical glass, a crystal, a semiconductor substrate such as a silicon substrate, or any other substrate.

Depending on the type of substrate, a pretreatment may be performed. For example, for plastic substrates, a plasma etching process can be performed first to achieve activation with a lowering of the contact angle. Subsequently, an inorganic layer can be applied, for example with a thickness of 1 to 3 nm. Subsequently, a patterned layer can be created, for example extending 10 to 200 nm into the substrate material. The pretreatment is not shown in the figures for simplified illustration. Subsequently, one or more inorganic layers 31 and a subsequent organic layer 41 are deposited.

The organic layers and the inorganic layers can each be multilayered. For example, the material for the inorganic layers each has a refractive index between 1.35 and 1.8 inclusive and the layer thickness is between 5 nm and 50 nm inclusive. One of the aforementioned organic materials, in particular a molecular structure derivable from purine, pyrimidine or triazine, or another of the further materials indicated above, is particularly suitable for the organic layer. The organic layers are preferably vacuum-deposited and preferably have a thickness between 80 nm and 1000 nm, inclusive. Subsequently, a plasma etching process is carried out, with which a structuring 5 of the organic layer takes place (FIG. 9B). A single structure of the structuring, such as an elevation 51, preferably has a height-to-width ratio of at least 1.0, particularly preferably of at least 2. During the formation of the structuring 5 by the plasma etching process, the chemical composition of the organic material in particular also changes.

Subsequently, an inorganic layer 32 with a refractive index of 1.35 to 1.8 and a thickness of, for example, 5 nm to 30 nm is deposited (FIG. 9C). The inorganic layer also covers the side surfaces of the elevations 51. Starting from the elevations 51, the inorganic layer can grow together between adjacent elevations 51, thereby creating cavities 6.

Subsequently, a post-treatment (FIG. 9D) is carried out, which changes the chemical composition of the last deposited organic material, which is located under an inorganic layer, thus reducing the refractive index of the material. This results in a modified structure 7 in the organic layer, with the decomposition of the organic material causing the altered refractive index. This results in an inorganic-organic hybrid material. In this process, the geometry or the height-to-width ratio of the previously created underlying structuring 5 is largely retained. This post-treatment can be achieved by a plasma etching process. In contrast to the formation of the structuring 5, the layer to be processed is covered by an inorganic layer. Alternatively or in addition to a post-treatment with a plasma etching process, a thermal treatment, for example at a temperature of at least 70°, can also be carried out.

Depending on the layer structure to be produced, the aforementioned steps of depositing one or more inorganic layers and subsequent deposition of one or more organic layers in conjunction with the production of a structured layer by a plasma etching process can also be repeated several times.

In FIG. 9E a method stage is shown in which a further organic layer 42 with a structuring 5A, a further inorganic layer 33 and again a further organic layer 43 have been deposited.

In FIG. 9F, the further organic layer 43 is provided with a structuring 5B.

A further inorganic layer 34 is deposited on this structuring 5B. Subsequently, a post-treatment can again be carried out as described in connection with FIG. 9D.

Finally, an inorganic cover layer 35 is deposited, for example with a refractive index between 1.35 and 1.8 inclusive and a thickness between 5 nm and 30 nm inclusive (FIG. 9H). The cover layer forms the uppermost layer of the reflection-reducing layer system 1.

Preferably, the same plasma source is always used for all plasma processes, for example a plasma source of the Leybold APS type.

All plasma processes, and if applicable also the post-treatment by a plasma process, can be carried out in a closed vacuum process. In the case of thermal post-treatment, this can also be carried out outside the apparatus. Details of the post-treatment are described in U.S. Pat. No. 10,782,451 (titled “Method for Producing a Reflection Reducing Layer System)(being based on a national application International Patent Application Publication No. WO 2018/115149 A1) which patent is incorporated herein by reference.

The invention is not limited by the description based on the exemplary embodiments. Rather, the invention encompasses any new feature as well as any combination of features, which in particular includes any combination of features in the patent claims, even if that feature or combination itself is not explicitly stated in the patent claims or the embodiments.

What is claimed is:

1. A layer system comprising:
an effective refractive index profile extending between a substrate-side surface and an interface with an ambient medium,
wherein an effective refractive index of the layer system decreases on average from the substrate-side surface in a direction of the interface with the ambient medium,
wherein the effective refractive index profile has at least two local minima, and
wherein a local minimum closest to the interface with the ambient medium is spaced from the interface.

2. The layer system according to claim 1, wherein the effective refractive index profile has at least two local maxima spaced from the substrate-side surface.

3. The layer system according to claim 2, wherein the effective refractive index in at least one local maximum is smaller than a refractive index of the substrate.

4. The layer system according to claim 2, wherein the effective refractive index in at least one of the local maxima is smaller than in a local maximum arranged between this local maximum and the substrate-side surface.

5. The layer system according to claim 1, wherein the effective refractive index in at least one of the local minima is between 1.05 and 1.12, inclusive.

6. The layer system according to claim 1, wherein the effective refractive index is between 1.14 and 1.40 inclusive from the interface with the ambient medium in the direction of the substrate for at least 10 nm.

7. The layer system according to claim 1, wherein the effective refractive index changes continuously at least between a local maximum and a local minimum at least in places.

8. The reflection-reducing layer system according to claim 1, wherein immediately at the interface with the ambient medium, the effective refractive index is greater than in a region of a local minimum closest to the interface with the ambient medium.

9. A method for manufacturing a layer system, the method comprising:
providing a substrate;
depositing an organic layer on an inorganic layer;
forming a structuring of the organic layer by a plasma etching process, wherein an elevation of the structuring has a height-to-width ratio of at least 1.0, and wherein a chemical composition of an organic material of the organic layer changes;
depositing at least one further inorganic layer;
performing a post-treatment in which the chemical composition of the organic material of the organic layer changes and a refractive index decreases; and
depositing an inorganic cover layer.

10. The method according to claim 9, wherein the organic layer comprises at least one annularly arranged grouping comprising conjugated nitrogen and carbon atoms, is vacuum deposited and has a thickness between 80 nm and 1000 nm, inclusive.

11. The method according to claim 9, wherein forming the structuring comprises forming depressions extending between 10 nm and 200 nm, inclusive, into the organic layer.

12. The method according to claim 9, wherein performing the post-treatment comprises performing the plasma etching process in which a basic shape of the structuring obtained by forming the structuring is preserved.

13. The method according to claim 9, wherein performing the post-treatment comprises performing a thermal treatment.

14. The method according to claim 9, wherein depositing the at least one further inorganic layer comprises growing the further inorganic layer on elevations of a side facing away from the substrate so that the further inorganic layer of adjacent elevations grows together thereby forming cavities.

15. The method according to claim 9, wherein depositing the organic layer on the inorganic layer, forming the structuring of the organic layer and depositing the at least one further inorganic layer are carried out repeatedly.

16. The method according to claim 9, wherein depositing the organic layer on the inorganic layer, forming the structuring of the organic layer and depositing the at least one further inorganic layer carried out in an apparatus in a closed vacuum process.
